(19) United States
(12) Patent Application Publication
(10) Pub. No.: US 2023/0014559 A1
(43) Pub. Date: Jan. 19, 2023

(54) HERBICIDAL COMPOSITIONS AND METHODS OF USE THEREOF

(71) Applicant: Valent U.S.A. LLC, San Ramon, CA (US)

(72) Inventors: Takashi Shibayama, Dublin, CA (US); Jessica Tanuwidjaja, Fremont, CA (US); Tak Wai Cheung, Mountain House, CA (US)

(21) Appl. No.: 17/941,431

(22) Filed: Sep. 9, 2022

Related U.S. Application Data
(63) Continuation-in-part of application No. 16/227,310, filed on Dec. 20, 2018.
(60) Provisional application No. 62/613,113, filed on Jan. 3, 2018.

(51) Int. Cl. A01N 43/707; A01N 43/84; A01N 43/80

(52) U.S. Cl. CPC A01N 43/707; A01N 43/84; A01N 43/80; A01N 25/04

(57) ABSTRACT

The present invention is directed to an aqueous herbicidal composition comprising metribuzin, flumioxazin, pyroxasulfone, and a polyoxyethylene alkyl sulfate. The present invention is further directed to a method of controlling weeds comprising applying a composition of the present invention to the weeds or an area in need of weed control.

### FIELD OF THE INVENTION

The present invention relates to an aqueous herbicidal composition comprising metribuzin, flumioxazin, pyroxasulfone and a polyoxyethylene alkyl sulfate. The present invention further relates to a method of controlling weeds comprising applying a composition of the present invention to the weeds or an area in need of weed control.

### BACKGROUND OF THE INVENTION

Unwanted plants, such as weeds, reduce the amount of resources available to crop plants and can have a negative effect on crop plant yield and quality. For example, a weed infestation reportedly was responsible for an 80% reduction in soybean yields. Bruce, J. A., and J. J. Kells, Horseweed (Conyza Canadensis) control in no-tillage soybeans (Glycine max) with preplant and preemergence herbicides, Weed Technol. 4:642-647 (1990). Therefore, controlling weeds is a major concern of crop growers. Unwanted plants in crop plant environments include broadleaves, grasses and sedges.

Often, when multiple herbicides are applied concurrently, they are added as suspension concentrates to form a tank mix prior to application. However, when adding multiple herbicide formulations to form a tank mix the user must ensure that the formulations are mixed homogenously to ensure good spray characteristics and consistent delivery of the active ingredients throughout the application area.

Flumioxazin is a protoporphyrinogen oxidase (“PPO”) inhibitor used as an herbicide to control weeds among soybeans, peanuts, orchard fruits and many other agricultural crops in the United States and worldwide. Flumioxazin is effective in controlling glyphosate-resistant and tough-to-control weeds.

Pyroxasulfone is relatively new isooxazoline herbicide that inhibits synthesis of very-long-chain fatty acids. Pyroxasulfone is used to control weeds among many agricultural crops including corn and soybean.

Metribuzin is a photosynthesis inhibiting herbicide used to control weeds among many agricultural crops including soybeans, potatoes, tomatoes and sugar cane. Metribuzin is often combined in the field with aqueous high-electrolyte herbicide formulations. For handling purposes during tank-mixing, it is most convenient to formulate metribuzin in the liquid (flowable) form. It would be even more desirable to obtain an aqueous suspension (rather than systems incorporating organic solvents), for environmental safety and phytotoxicity purposes. However, metribuzin is partially water soluble (1050 mg/L at 20° C.) causing it to be prone to crystal growth in these aqueous formulations via Ostwald ripening.

Accordingly, there is a need in the art for herbicide compositions that can stabilize metribuzin in an aqueous formulation.

### SUMMARY OF THE INVENTION

In one embodiment, the present invention is directed to an aqueous herbicidal composition comprising metribuzin, flumioxazin, pyroxasulfone and a polyoxyethylene alkyl sulfate.

In another embodiment, the present invention is directed to a method of controlling weeds comprising applying a composition of the present invention to the weeds or an area in need of weed control.

### BRIEF DESCRIPTION OF THE DRAWINGS

FIG. 1. Metribuzin solubility in salt solutions.

### DETAILED DESCRIPTION OF THE INVENTION

Applicant surprisingly discovered that the addition of s a polyoxyethylene alkyl sulfate resulted in stable aqueous metribuzin compositions.

In one embodiment, the present invention is directed to an aqueous herbicidal composition comprising:

metribuzin;

flumioxazin;

pyroxasulfone; and

a polyoxyethylene alkyl sulfate.

In a preferred embodiment, metribuzin is present at a concentration from about 1% to about 50% w/w, from about 1% to about 45% w/w, from about 1% to about 38% w/w, from about 10% to about 20% w/w, from about 15% to about 17% w/w, about 15.9% w/w or about 15.86% w/w.

In another preferred embodiment, flumioxazin is present at a concentration from about 1% to about 15% w/w, from about 4% to about 12% w/w, about 5.3% w/w or about 5.29% w/w.

In yet another preferred embodiment, pyroxasulfone is present at a concentration from about 1% to about 10% w/w, from about 5% to about 7% w/w, about 6.8% w/w or about 6.76% w/w.

As used herein, “salting-out agent” or “salting-out agents” are compounds that lower the water solubility of metribuzin.

In a preferred embodiment, the salting-out agent is a salt having a molecular weight less than about 500 grams per mole and a water solubility of greater than about 20% w/w at a temperature from about 20 to about 25 degrees Celsius.

In a preferred embodiment, the salting-out agent is a salt having a cation selected from the group consisting of aluminum, ammonium, potassium, sodium, lithium, magnesium, calcium and iron and or an anion selected from the group consisting of citrate, tartrate, fluoride, sulfate, sulfonate, phosphate/hydrogenphosphate, acetate, chloride, nitrate, bromide, chlorate, iodide, perchlorate and thiocyanate. More preferably, the salting-out agent is selected from ammonium sulfate, ammonium acetate and potassium citrate.

In another preferred embodiment, the salting-out agent is present at a concentration from about 1% to about 10% w/w, from about 1% to about 6% w/w, from about 1.8% to about 3.0% w/w, from about 2.0% to about 2.9% w/w or about 2.0% w/w, about 2.8% w/w or about 2.9% w/w.

In another preferred embodiment, the polyvinyl alcohol is present at a concentration from about 1% to about 10% w/w, from about 1% to about 5% w/w, from about 1.2% to about 3.0% w/w or from about 1.4% to about 2.9% w/w or about 1.4% w/w, about 1.5% w/w, about 2.8% w/w or about 2.9% w/w.

In one embodiment, the present invention is directed to an aqueous herbicidal composition comprising:

metribuzin;

flumioxazin;

pyroxasulfone; and

a polyoxyethylene alkyl sulfate.

In a preferred embodiment, the present invention is directed to an aqueous herbicidal composition comprising:
from about 10% to about 20% w/w metribuzin, preferably from about 15% to about 17% w/w;
from about 1% to about 15% w/w of flumioxazin, preferably from about 4% to about 12% w/w;
from about 1% to about 10% w/w pyroxasulfone, preferably from about 5% to about 7% w/w; and
from about 0.1% to about 8% w/w sodium alkyl naphthalene sulfonate condensate, preferably from about 4% to about 6% w/w; and
optionally,
from about 0.1% to about 4% w/w magnesium aluminum silicate, preferably from about 0.1% to about 1% w/w;
from about 0.1% to about 4% w/w xanthan gum, preferably from about 0.1% to about 1% w/w; and
further optionally,
from about 1% to about 7% w/w propylene glycol, preferably from about 2% to about 6% w/w;
from about 5% w/w to about 15% w/w glycerol, preferably from about 8% to about 12% w/w;
from about 0.05% to about 1% w/w of a silicone emulsion, preferably from about 0.2% to about 0.4% w/w; and
from about 0.1% to about 1% w/w of 19.3% 1, 2-benzisothiazolin-3-one, preferably
from about 0.1% to about 0.3% w/w.

In an even more preferred embodiment, the present invention is directed to an aqueous herbicidal composition comprising:
about 15.9% w/w metribuzin;
about 5.3% w/w flumioxazin;
about 6.8% w/w pyroxasulfone;
about 5% w/w of sodium alkyl naphthalene sulfonate condensate;
about 0.5% w/w magnesium aluminum silicate; and
about 0.13% w/w xanthan gum, and
optionally,
about 4% w/w propylene glycol;
about 10% w/w glycerol;
about 0.3% w/w of a silicone emulsion; and
about 0.2% w/w of 19.3% 1, 2-benzisothiazolin-3-one.

In another preferred embodiment, the present invention is directed to an aqueous herbicidal composition comprising:
from about 10% to about 20% w/w metribuzin;
from about 1% to about 15% w/w of flumioxazin;
from about 1% to about 10% w/w pyroxasulfone;
from about 1% to about 6% w/w of a salt selected from ammonium sulfate, ammonium acetate and potassium citrate; and
from about 1% to about 5% w/w polyvinyl alcohol.

In another preferred embodiment, the present invention is directed to an aqueous herbicidal composition comprising:
from about 15% to about 17% w/w metribuzin;
from about 4% to about 12% w/w flumioxazin;
from about 5% to about 7% w/w pyroxasulfone;
ammonium sulfate at a concentration from about 1.8% to about 3.0% w/w; and
polyvinyl alcohol at a concentration from about 1.2% to about 3.0% w/w.

In another preferred embodiment, the present invention is directed to an aqueous herbicidal composition comprising:
about 15.9% w/w metribuzin;
about 5.3% w/w flumioxazin;
about 6.8% w/w pyroxasulfone;
about 2.8% w/w ammonium sulfate; and
about 2.8% w/w polyvinyl alcohol.

In another preferred embodiment, the present invention is directed to an aqueous herbicidal composition comprising:
about 15.9% w/w metribuzin;
about 5.3% w/w flumioxazin;
about 6.8% w/w pyroxasulfone;
about 2.0% w/w ammonium sulfate; and
about 1.4% w/w polyvinyl alcohol.

In another preferred embodiment, the present invention is directed to an aqueous herbicidal composition comprising:
about 15.9% w/w metribuzin;
about 5.3% w/w flumioxazin;
about 6.8% w/w pyroxasulfone;
about 2.8% w/w ammonium sulfate;
about 2.8% w/w polyvinyl alcohol;
about 4% w/w of a 35% acrylic graft copolymer;
about 2% w/w of an alkylphenol ethoxylate free nonionic wetter;
about 4% w/w propylene glycol;
about 0.1% w/w of a silicone emulsion;
about 0.15% w/w of a mixture of 1.15% 5-chloro-2-methyl-4-isothiazolin-3-one and 0.35% 2-methyl-4-isothiazolin-3-one; and
about 1% w/w magnesium aluminum silicate.

In another preferred embodiment, the present invention is directed to an aqueous herbicidal composition comprising:
about 15.9% w/w metribuzin;
about 5.3% w/w flumioxazin;
about 6.8% w/w pyroxasulfone;
about 2.0% w/w ammonium sulfate;
about 1.4% w/w polyvinyl alcohol;
from about 4% to about 6% w/w of a 35% acrylic graft copolymer;
about 2% w/w of an alkylphenol ethoxylate free nonionic wetter;
about 4% w/w propylene glycol;
about 0.3% w/w of a silicone emulsion;
about 0.2% w/w of 19.3% 1, 2-benzisothiazolin-3-one;
from about 0.50% to about 0.75% w/w magnesium aluminum silicate; and
from about 0.15% to about 0.225% w/w hydroxyethyl cellulose.

In another preferred embodiment, the present invention is directed to an aqueous herbicidal composition comprising:
about 15.9% w/w metribuzin;
about 5.3% w/w flumioxazin;
about 6.8% w/w pyroxasulfone;
about 5% w/w of sodium alkyl naphthalene sulfonate condensate;
about 4% w/w propylene glycol;
about 10% w/w glycerol;
about 0.3% w/w of a silicone emulsion;
about 0.2% w/w of 19.3% 1, 2-benzisothiazolin-3-one;
about 0.5% w/w magnesium aluminum silicate; and
about 0.13% w/w xanthan gum.

Compositions of the present invention may further comprise one or more excipients selected from the group consisting of a surfactant, an antifoaming agent, an antifreeze agent, a preservative and a thickener.

Surfactants suitable for use in the present invention include, but are not limited to, polyoxyethylene aryl or alkyl phosphates or sulfates such as potassium salt of polyoxyethylene tristyrylphenol phosphate, sodium alkyl naphthalene sulfonate condensate, dodecylbenzene sulfonate salts, methyloxirane polymer, styrene methacrylic copolymer, polyvinylpyrrolidone and methyl vinyl ether/maleic acid half ester copolymer, acrylic graft copolymers and an alkylphenol ethoxylate free nonionic wetter.

In another preferred embodiment, the 35% acrylic graft copolymer may be present at a concentration from about 0.1% to about 8% w/w, more preferably from about 2% to about 7% w/w, even more preferably from about 4% to about 6% w/w and most preferably about 4% w/w or about 6% w/w.

In another preferred embodiment, the 35% acrylic graft copolymer has a density of 1.07 g/mL at 25° C., a flash point of greater than 100° C., a pour point of less than 0° C. and a viscosity of 200 mPa·s at 25° C.

In another preferred embodiment, the alkylphenol ethoxylate free nonionic wetter may be present at a concentration from about 0.1% to about 5% w/w, from about 1% to about 3% w/w or about 2% w/w.

In another preferred embodiment, the potassium salt of polyoxyethylene tristyrylphenol phosphate may be present at a concentration from about 0.1% to about 5% w/w, from about 1% to about 3% w/w or about 2% w/w.

In another preferred embodiment, the sodium alkyl naphthalene sulfonate condensate may be present at a concentration from about 0.1% to about 8% w/w, more preferably from about 2% to about 7% w/w, even more preferably from about 4% to about 6% w/w and most preferably about 5% w/w.

Antifoaming agents suitable for use in the present invention include, but are not limited to, silicone antifoaming agents including silicone emulsions, vegetable oils, acetylenic glycols, and high molecular weight adducts of propylene oxide and lower polyoxyethylene and polyoxypropylene block polymers (wherein the number of octyl-, nonyl- and phenylpolyoxyethylene/ethylene oxide units is >5) and long-chain alcohols and mixtures thereof. In a preferred embodiment, the antifoaming agent is a silicone emulsion. Antifoaming agents may be present at a concentration from about 0.01% to about 1% w/w, from about 0.05% to about 0.5% w/w or from about 0.1% to about 0.3% w/w, or from about 0.2% to about 0.4% w/w or about 0.1% w/w, about 0.15% w/w or about 0.3% w/w.

Antifreeze agents suitable for use in the present invention include, but are not limited to, ethylene glycol, propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, and bisphenols such as bisphenol A. In a preferred embodiment, the antifreeze agent is propylene glycol, glycerol or a mixture thereof. Antifreeze agents may be present at a concentration from about 1% to about 20% w/w, from about 1% to about 7% w/w, from about 5% to about 15% w/w, preferably from about 8% to about 12% or from about 2% to about 6% w/w and most preferably at about 4% w/w, about 6% w/w, about 10% w/w or about 14% w/w.

Preservatives suitable for use in the present invention include, but are not limited to, a mixture of 5-chloro-2-methyl-4-isothiazolin-3-one and 2-methyl-4-isothiazolin-3-one, 1, 2-benzisothiazolin-3-one and a mixture of 1, 2-benzisothiazolin-3-one and 2-bromo-2-nitro-1,3-propanediol. In a preferred embodiment the preservative is 19.3% 1, 2-benzisothiazolin-3-one or a mixture of 5-chloro-2-methyl-4-isothiazolin-3-one and 2-methyl-4-isothiazolin-3-one, 1, 2-benzisothiazolin-3-one. Preservatives may be present at a concentration from about 0.1% to about 1% w/w, from about 0.1% to about 0.3% w/w, about 0.15% w/w or about 0.2% w/w.

Thickeners suitable for use in the present invention include, but are not limited to, magnesium aluminum silicate, hydrophilic fumed silica, aluminum oxide, hydroxy alkyl celluloses, xanthan gum and mixtures thereof. Preferred hydroxy alkyl celluloses include hydroxyethyl cellulose. Thickeners may be present at a concentration from about from about 0.1% to about 4.0% w/w, from about 0.1% to about 1% w/w, from about 0.7% to about 2% w/w, from about 0.5% to about 1.0% w/w, about 0.1% w/w, about 0.13% w/w, about 0.15% w/w, about 0.5% w/w, about 0.6% w/w, about 0.725% w/w, about 0.75% w/w, about 0.8% w/w, about 0.9% w/w, about 0.96% w/w or about 1% w/w.

In another embodiment, the present invention is directed to a method of controlling a weed comprising applying the composition of the present invention to the weed or an area in need of weed control.

In another embodiment, the present invention is directed to a method of controlling a weed comprising applying the composition of the present invention sequentially or concurrently with a compound selected from the group consisting of glyphosate, glufosinate, dicamba, 2,4-D and mixtures thereof to the weed or an area in need of weed control.

The compositions of the present invention can be applied to any environment in need of weed control. The environment in need of weed control may include any area that is desired to have a reduced number of weeds or to be free of weeds. For example, the composition can be applied to an area used to grow crop plants, such as a field, orchard, or vineyard. For example, compositions and methods of the present invention can be applied to areas where soybeans, corn, peanuts, and cotton are growing. In a preferred embodiment, the composition is applied in an area where a broadleaf crop (soybean, cotton, peanut, orchard, vineyard, forages) is growing. The compositions of the present invention can also be applied to non-agricultural areas in need of weed control such as lawns, golf courses, or parks.

The compositions of the present invention can be applied by any convenient means. Those skilled in the art are familiar with the modes of application that include foliar applications such as spraying and chemigation (a process of applying the composition through the irrigation system).

The compositions of the present invention can be prepared as concentrate formulations or as ready-to-use formulations. The compositions can be tank mixed.

The compositions and methods of the present invention can be applied successfully to crop plants and weeds that are resistant to glyphosate, glufosinate, or other herbicides. The composition and methods can also be applied to areas where genetically modified crops (“GMOs”) or non-GMO crops are growing. The term “GMO crops” as used herein refers to crops that are genetically modified.

Throughout the application, the singular forms “a,” “an,” and “the” include plural reference unless the context clearly dictates otherwise.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

These representative embodiments are in no way limiting and are described solely to illustrate some aspects of the invention.

Further, the following examples are offered by way of illustration only and not by way of limitation.

### EXAMPLES

TABLE 1
Compositions of the Invention

| Composition | 1 | 2 | 3 | 4 | 5 | 6 | 7 |
|---|---|---|---|---|---|---|---|
| Metribuzin | 15.86% | 15.86% | 15.86% | 15.86% | 15.86% | 15.86% | 15.86% |
| Pyroxasulfone | 6.76% | 6.76% | 6.76% | 6.76% | 6.76% | 6.76% | 6.76% |
| Flumioxazin | 5.29% | 5.29% | 5.29% | 5.29% | 5.29% | 5.29% | 5.29% |
| 35% Acrylic graft | 4% | 4% | 4% | 4% | 4% | 6% | 4% |
| copolymer | | | | | | | |
| Alkylphenol ethoxylate | 2% | 2% | 2% | — | 2% | 2% | 2% |
| free nonionic wetter | | | | | | | |
| Polyoxyethylene | — | — | — | 2% | — | — | — |
| tristyrylphenol phosphate, | | | | | | | |
| potassium salt | | | | | | | |
| Propylene glycol | 6% | 4% | 4% | 4% | 4% | 4% | 4% |
| Glycerol | — | — | — | — | — | — | — |
| Polyvinyl alcohol (as | 0%-2.9% | 0%-2.8% | 0%-2.8% | 0%-2.8% | 1.4% | 1.4% | 1.5% |
| active) | | | | | | | |
| Ammonium sulfate | 0%-2.9% | 0%-2.8% | 0%-2.8% | 0%-2.8% | 2.0% | 2.0% | 2.8% |
| Potassium citrate | — | 0%-5.6% | — | — | — | — | — |
| Silicone emulsion | 0.1% | 0.1% | 0.1% | 0.1% | 0.3% | 0.3% | 0.15% |
| Mixture of 1.15% 5- | — | 0.15% | 0.15% | 0.15% | — | — | 0.15% |
| chloro-2-methyl-4- | | | | | | | |
| isothiazolin-3-one and | | | | | | | |
| 0.35% 2-methyl-4- | | | | | | | |
| isothiazolin-3-one | | | | | | | |
| 19.3% 1,2-benzisothiazolin-3- | 0.2% | — | — | | 0.2% | 0.2% | — |
| one | | | | | | | |
| Magnesium aluminum | 0.5% | 1% | — | 1% | 0.5% | 0.75% | 1.0% |
| silicate | | | | | | | |
| Hydrophilic fumed silica | — | — | 0.8% | — | — | — | — |
| Aluminum oxide | — | — | 0.16% | — | — | — | — |
| Xanthan gum | 0.1% | — | — | — | — | — | — |
| Hydroxyethyl cellulose | — | — | — | — | 0.225% | 0.15% | — |

Tersperse® 2500 is used as the source of 35% graft copolymer and is available from Huntsman Petrochemical Corporation.

Tersperse® 4894 (CAS #68131-39-5) is used as the source of alkylphenol ethoxylate free nonionic wetter and dispersant package (Tersperse is a registered trademark of and is available from Huntsman Petrochemical Corporation).

Stepfac™ TSP PE-K (CAS #163436-84-8) is used as the source of polyoxyethylene tristyrylphenol phosphate, potassium salt and is available from Stepan Corp.

Selvol® 24-203, 9-523 (CAS #25213-24-5) or Selvol® 15-103 (CAS #9002-89-5) are used as the sources of polyvinyl alcohol and are available from Sekisui Specialty Chemicals America, LLC.

Xiameter® AFE-0010 is used as the source of silicone emulsion and is available from Dow Corning Corporation.

Kathon® CG/ICP is used as the source of a mixture of 1.15% 5-chloro-2-methyl-4-isothiazolin-3-one (CAS #26172-55-4) and 0.35% 2-methyl-4-isothiazolin-3-one (CAS #2682-20-4) and is available from Dow Chemical Company.

Proxel® GXL is used as the source of 19.3% 1, 2-benzisothiazolin-3-one and is a registered trademark of Arch UK Biocides and is available from Lonza.

Van Gel® B (CAS #1302-78-9 or #12199-37-0) or Veegum® R (CAS #1302-78-9 or #12199-37-0) is used as the source of magnesium aluminum silicate and is available from Vanderbilt Minerals, LLC.

Aerosil® 200 (CAS #112 945-52-5, 7631-86-9) is used as the source of hydrophilic fumed silica and is available from Evonik Industries.

Aeroxide® Alu C (CAS #1344-28-1) is used as the source of aluminum oxide and is available from Evonik Industries.

Kelzan® BT is used as the source of xanthan gum and is available from CP Kelco.

Cellosize® QP 100MH is used as the source of hydroxyethyl cellulose and is available from Dow Chemical Company.

### Example 1—Processes for Preparation of Compositions of the Invention

### Process 1

The salting-out agent was dissolved in water while stirring. Excipients including antifreeze agent, surfactants, polyvinyl alcohol, antifoam agent, and preservative were then added sequentially under continuous agitation until the composition was homogeneous. Once homogenous, metribuzin and optionally, other active ingredients were added to the composition. After mixing under high-shear agitation, the composition was wet milled to a median particle size of about 2 micrometers (“μM”) using zirconia beads to create a mill base. Separately, the thickener was added to water under high-shear agitation to create a thickener dispersion. Post-milling, the thickener dispersion was added and blended with the mill base. If necessary, additional water was added to adjust the composition to the final desired active ingredient(s) concentration.

### Process 2

Excipients including antifreeze agent, surfactants, polyvinyl alcohol, antifoam agent, and preservative were added sequentially to water under continuous agitation until the composition was homogeneous. Once homogenous, metribuzin and optionally, other active ingredients were added to the composition. After mixing under high-shear agitation, the composition was wet milled to a median particle size of about 2 μM using zirconia beads to create a mill base. Separately, the thickener was added to water under high-shear agitation to create a thickener dispersion. Post milling, a solution of the salt in water was added to the mill base with agitation. The thickener dispersion was then added and blended with the mill base. If necessary, additional water was added to adjust the composition to the final desired active ingredient(s) concentration.

### Process 3

Thickener was added to water under continuous agitation, which continued until the composition was homogenous (about 15-20 minutes) to create a thickener dispersion. Excipients such as antifreeze agent, surfactants, polyvinyl alcohol, antifoam agent, and preservative were added sequentially to the thickener dispersion under continuous agitation to create excipient solution. Once homogenous, metribuzin and optionally, other active ingredients were added to the excipient solution to create a millable dispersion. After mixing under high-shear agitation, the millable dispersion was wet milled to a median particle size of about 2 μM using zirconia beads to create a mill base. Post milling, a solution of the salt in water was added to the mill base with agitation. If necessary, additional water was added to adjust the composition to the final desired active ingredient(s) concentration.

### Example 2—Metribuzin Solubility in Salt Solutions

### Method

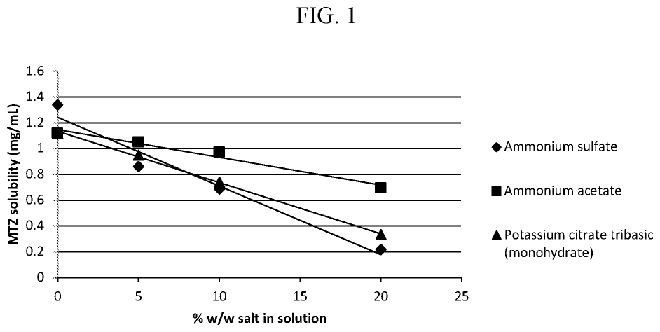

Metribuzin is partially soluble in water. Because of its partial solubility metribuzin grows crystals in aqueous solutions. It is a discovery of the present invention that, if water solubility of metribuzin is lowered, then crystal growth is inhibited or reduced. To determine if salts could lower the water solubility of metribuzin, metribuzin was added to the saturation point to several concentrations of ammonium sulfate, ammonium acetate and potassium citrate tribasic monohydrate solutions. Results can be seen in FIG. 1.

### Results

As seen in FIG. 1, the concentration of each of ammonium sulfate, ammonium acetate and potassium citrate tribasic monohydrate was negatively correlated with the water solubility of metribuzin. These results are evidence that salts can lower the water solubility of metribuzin.

### Example 3—Metribuzin Stability

### Method

Variations of Composition 1 from Table 1, above, were subjected to extreme temperatures to determine long-term storage stability including the likelihood of large crystals growing that cause clogging of the spray nozzle by performing the wet sieve test. Specifically, these compositions containing various amounts of polyvinyl alcohol and ammonium sulfate were subjected to 2 weeks at 54° C. and 4 weeks at 50° C. accelerated aging. The wet sieve test typically was performed soon after the samples were brought back to room temperature using the following protocol:

A bottle containing the composition was emptied onto a 100-mesh sieve positioned on top of a receiver. Water was added to the bottle, shaken to rinse, and the rinse solution was poured onto the mesh to wash off the material. The rinsing step was repeated until visible quantity of residue on the mesh remained constant. If necessary, additional, minimum streams of water were introduced by way of a squirt or spray bottle to further clear the mesh. Typically, about 250 milliliters of water was used for about 40 grams of sample. The mesh was then dried to a constant weight and observed under a microscope.

Percent wet sieve residue is calculated by the following equation: mass sieve residue/mass sample*100, and presented as a percentage of residue that did not pass through a 100-mesh sieve. Results can be seen in Table 2, below.

TABLE 2

| Composition | 1A | 1B | 1C | 1D |
|---|---|---|---|---|
| polyvinyl alcohol | — | — | 2.9% | 2.9% |
| (as active/solid) | | | | |
| ammonium sulfate | — | 2.9% | — | 2.9% |

Sieve Residue % (<0.05% desirable)

| | | | | |
|---|---|---|---|---|
| 54° C. (2 weeks) | n/a | n/a | n/a | n/a |
| | Crystals | No crystals | Crystals | No crystals |
| 50° C. (4 weeks) | 0.013% | 0.020% | 0.032% | 0.046% |
| | Crystals | Crystals | Crystals | No crystals |

n/a denotes that exact value of percent wet sieve residue was not obtained and only visual examination of crystal growth was performed.

### Results

As can be seen in Table 2, Compositions 1B and 1D inhibited crystal growth. Thus, polyvinyl alcohol alone is not sufficient to inhibit metribuzin crystal growth.

### Example 4—Metribuzin Stability

### Method

Variations of Composition 2 from Table 1, above, were subjected to several conditions to determine long-term storage stability including % wet sieve test residue. Specifically, these compositions contained 0% or 2.8% w/w of polyvinyl alcohol and 0% or 2.8% w/w ammonium sulfate or 0% or 2.8% or 5.6% w/w potassium citrate and were subjected to 2 weeks at 54° C. and 4 weeks at 50° C. Results can be seen in Table 3 below.

TABLE 3

| Composition | 2A | 2B | 2C | 2D | 2E | 2F |
|---|---|---|---|---|---|---|
| polyvinyl alcohol | — | — | 2.8% | — | — | 2.8% |
| (as active/solid) | | | | | | |
| Ammonium sulfate | — | 2.8% | 2.8% | — | — | — |
| Potassium citrate | — | — | — | 2.8% | 5.6% | 2.8% |

Sieve Residue % (<0.05% desirable)

| | | | | | | |
|---|---|---|---|---|---|---|
| 54° C. (2 weeks) | 0.024\hat{ } | 0.024 | 0.002 | 0.01 | 0.006 | 0.007 |
| 50° C. (4 weeks) | 0.007\hat{ } | 0.006* | 0.005* | 0.005 | 0.007 | 0.006 |

*denotes presence of small crystals.
\hat{ }denotes presence of large crystals.

### Results

Ammonium sulfate reduced crystal growth to small crystals that mostly do not get caught in the sieve when sprayed. Potassium citrate completely inhibited crystal growth under these accelerated aging conditions. The addition of polyvinyl alcohol further reduced crystal growth and lowered sieve residue for compositions containing ammonium sulfate.

### Example 5—Metribuzin Stability

### Method

Variations of Composition 3 from Table 1 above were subjected to several conditions to determine long-term storage stability including % wet sieve test residue. Specifically, these compositions contained 0 or 2.8% w/w of polyvinyl alcohol and 0% or 2.8% w/w ammonium sulfate and were subjected to 2 weeks at 54° C. Results can be seen in Table 4 below.

TABLE 4

| Composition | 3A | 3B | 3C |
|---|---|---|---|
| polyvinyl alcohol | — | — | 2.8% |
| (as active/solid) | | | |
| Ammonium sulfate | — | 2.8% | 2.8% |

Sieve Residue % (<0.05% desirable)

| | | | |
|---|---|---|---|
| 54° C. (2 weeks) | 0.008\hat{ } | 0.003\hat{ } | 0.003 |

\hat{ }denotes presence of large crystals.

### Results

Ammonium sulfate reduced the amount of crystals isolated on the sieve substantially. The addition of polyvinyl alcohol further reduced crystal growth and lowered sieve residue.

### Example 6—Metribuzin Stability

### Method

Variations of Composition 4 from Table 1, above, were subjected to several conditions to determine long-term storage stability including % wet sieve test residue. Specifically, these compositions contained 0% or 2.8% w/w of polyvinyl alcohol and 0% or 2.8% w/w ammonium sulfate and were subjected to 2 weeks at 54° C. Results can be seen in Table 5 below.

TABLE 5

| Composition | 4A | 4B | 4C |
|---|---|---|---|
| polyvinyl alcohol | — | — | 2.8% |
| (as active/solid) | | | |
| Ammonium sulfate | — | 2.8% | 2.8% |

Sieve Residue % (<0.05% desirable)

| | | | |
|---|---|---|---|
| 54° C. (2 weeks) | 0.004\hat{ } | 0.006 | 0.004 |

\hat{ }denotes presence of large crystals.

### Results

Ammonium sulfate inhibited crystal growth and lowered sieve residue. The addition of polyvinyl alcohol further lowered sieve residue.

### Example 7—Metribuzin Stability

### Method

Compositions 5-7 from Table 1, above, were subjected to several conditions to determine long-term storage stability including % wet sieve test residue. Specifically, these compositions contained 1.4% or 1.5% w/w of polyvinyl alcohol and 2.0% or 2.8% w/w ammonium sulfate and were subjected to 2 weeks at 54° C. and 4 weeks at 50° C. Results can be seen in Table 6 below.

TABLE 6

| Composition | 5 | 6 | 7 |
|---|---|---|---|
| polyvinyl alcohol | 1.4% | 1.4% | 1.5% |
| (as active/solid) | | | |
| Ammonium sulfate | 2.0% | 2.0% | 2.8% |

Sieve Residue % (<0.05% desirable)

| | | | |
|---|---|---|---|
| 54° C. (2 weeks) | 0.005 | 0.004 | 0.007* |
| 50° C. (4 weeks) | 0.003* | 0.005* | 0.008 |

*denotes presence of small crystals.

### Results

The combination of ammonium sulfate and polyvinyl alcohol helped reduce crystal growth such that only very low amounts (<0.008%) of small crystals, if any, were isolated under these high temperature conditions.

Thus, it can be seen from examples in Tables 2-6 that the combination of a salting-out agent and polyvinyl alcohol greatly reduces the chance of large metribuzin crystals clogging the spray nozzle during application of this formulation.

### Example 8—Metribuzin Stability

TABLE 7

| Composition | X | A | B | C | C-2 | D | E | F |
|---|---|---|---|---|---|---|---|---|
| Metribuzin | 15.86 | 15.86 | 15.86 | 15.86 | 15.86 | 15.86 | 15.86 | 15.86 |
| Pyroxasulfone | 6.76 | 6.76 | 6.76 | 6.76 | 6.76 | 6.76 | 6.76 | 6.76 |
| Flumioxazin | 5.29 | 5.29 | 5.29 | 5.29 | 5.29 | 5.29 | 5.29 | 5.29 |
| 35% graft copolymer | 4.00 | 4.00 | 4.00 | 4.00 | 4.00 | 4.00 | 4.00 | 4.00 |
| Alkylphenol ethoxylate free | 2.00 | 2.00 | 2.00 | 2.00 | 2.00 | 2.00 | 2.00 | 2.00 |
| nonionic wetter and dispersant | | | | | | | | |
| package | | | | | | | | |
| A lignin, alkali, reaction product | — | — | — | — | — | — | — | 4.00 |
| with formaldehyde and sodium | | | | | | | | |
| bisulfite | | | | | | | | |
| An ethoxylated kraft | — | — | — | — | — | — | — | — |
| lignosulfonate | | | | | | | | |
| Sodium alkyl naphthalene | — | — | — | — | — | — | — | — |
| sulfonate condensate | | | | | | | | |
| Propylene glycol | 4.00 | 4.00 | 4.00 | 4.00 | 4.00 | 4.00 | 4.00 | 4.00 |
| Glycerol | — | — | — | — | — | — | — | — |
| PVA (as active) | 1.40 | 1.40 | 1.40 | 1.40 | 1.40 | 1.40 | 1.40 | 1.40 |
| Ammonium sulfate | 2.00 | 2.00 | 2.00 | — | — | 2.00 | 2.00 | — |
| Silicone emulsion | 0.30 | 0.30 | 0.30 | 0.30 | 0.30 | 0.30 | 0.30 | 0.30 |
| 19.3% 1,2-benzisothiazolin-3- | 0.20 | 0.20 | 0.20 | 0.20 | 0.20 | 0.20 | 0.20 | 0.20 |
| one | | | | | | | | |
| Magnesium aluminum silicate | 0.50 | 0.50 | 0.50 | 0.50 | 0.50 | 0.50 | 0.50 | 0.50 |
| Hydroxyethyl cellulose | 0.23 | 0.34 | — | — | — | — | — | — |
| 10% microfibrillated cellulose | — | — | — | — | — | — | — | — |
| Xanthan gum | — | — | 0.22 | 0.23 | 0.34 | — | — | 0.23 |
| Diutan gum | — | — | — | — | — | 0.14 | 0.14 | — |
| Water | Q.S. | Q.S. | Q.S. | Q.S. | Q.S. | Q.S. | Q.S. | Q.S. |
| Composition | G | H | I | J | K | L | M | N |
| Metribuzin | 15.86 | 15.86 | 15.86 | 15.86 | 15.86 | 15.86 | 15.86 | 15.86 |
| Pyroxasulfone | 6.76 | 6.76 | 6.76 | 6.76 | 6.76 | 6.76 | 6.76 | 6.76 |
| Flumioxazin | 5.29 | 5.29 | 5.29 | 5.29 | 5.29 | 5.29 | 5.29 | 5.29 |
| 35% graft copolymer | 4.00 | — | — | 2.00 | 2.00 | — | — | — |
| Alkylphenol ethoxylate free | 2.00 | — | — | 1.00 | 1.00 | — | — | — |
| nonionic wetter and dispersant | | | | | | | | |
| package | | | | | | | | |
| A lignin, alkali, reaction product | — | 4.00 | — | 2.00 | — | 2.00 | 2.00 | 3.00 |
| with formaldehyde and sodium | | | | | | | | |
| bisulfite | | | | | | | | |
| An ethoxylated kraft | 4.00 | — | 4.00 | — | 2.00 | — | — | — |
| lignosulfonate | | | | | | | | |
| Sodium alkyl naphthalene | — | — | — | — | — | — | — | — |
| sulfonate condensate | | | | | | | | |
| Propylene glycol | 4.00 | 4.00 | 4.00 | 4.00 | 4.00 | 4.00 | 4.00 | 4.00 |
| Glycerol | — | — | — | — | — | — | — | — |
| PVA (as active) | 1.40 | 1.40 | 1.40 | 1.40 | 1.40 | 1.40 | 1.40 | 1.40 |
| Ammonium sulfate | — | — | — | — | — | — | — | — |
| Silicone emulsion | 0.30 | 0.30 | 0.30 | 0.30 | 0.30 | 0.30 | 0.30 | 0.30 |
| 19.3% 1,2-benzisothiazolin-3- | 0.20 | 0.20 | 0.20 | 0.20 | 0.20 | 0.20 | 0.20 | 0.20 |
| one | | | | | | | | |
| Magnesium aluminum silicate | 0.50 | 0.50 | 0.50 | 0.50 | 0.50 | 0.50 | 0.50 | 0.50 |
| Hydroxyethyl cellulose | — | — | — | — | — | — | — | — |
| 10% microfibrillated cellulose | — | — | — | — | — | — | — | — |
| Xanthan gum | 0.23 | 0.23 | 0.23 | 0.23 | 0.23 | 0.20 | — | — |
| Diutan gum | — | — | — | — | — | — | 0.12 | — |
| Water | Q.S. | Q.S. | Q.S. | Q.S. | Q.S. | Q.S. | Q.S. | Q.S. |
| Composition | O | P | Q | R | T | U | V | W |
| Metribuzin | 15.86 | 15.86 | 15.86 | 15.86 | 15.86 | 15.86 | 15.86 | 15.86 |
| Pyroxasulfone | 6.76 | 6.76 | 6.76 | 6.76 | 6.76 | 6.76 | 6.76 | 6.76 |
| Flumioxazin | 5.29 | 5.29 | 5.29 | 5.29 | 5.29 | 5.29 | 5.29 | 5.29 |
| 35% graft copolymer | 0.60 | 0.60 | — | — | — | — | — | — |
| Alkylphenol ethoxylate free | 0.30 | 0.30 | — | — | — | — | — | — |
| nonionic wetter and dispersant | | | | | | | | |
| package | | | | | | | | |
| A lignin, alkali, reaction product | 3.00 | 3.00 | 3.00 | 3.00 | 3.00 | 3.00 | 3.00 | 8.00 |
| with formaldehyde and sodium | | | | | | | | |
| bisulfite | | | | | | | | |
| An ethoxylated kraft | — | — | — | — | — | — | — | — |
| lignosulfonate | | | | | | | | |
| Sodium alkyl naphthalene | — | — | — | — | — | — | — | — |
| sulfonate condensate | | | | | | | | |
| Propylene glycol | 4.00 | 4.00 | 4.00 | 4.00 | 4.00 | 4.00 | 4.00 | 4.00 |
| Glycerol | — | — | — | — | 10.00 | 10.00 | 10.00 | 10.00 |
| PVA (as active) | 1.40 | 1.40 | — | — | — | — | — | — |
| Ammonium sulfate | — | — | — | — | — | — | — | — |
| Silicone emulsion | 0.30 | 0.30 | 0.30 | 0.30 | 0.30 | 0.30 | 0.30 | 0.30 |
| 19.3% 1,2-benzisothiazolin-3- | 0.20 | 0.20 | 0.20 | 0.20 | 0.20 | 0.20 | 0.20 | 0.20 |
| one | | | | | | | | |
| Magnesium aluminum silicate | 0.50 | 0.50 | 0.50 | 0.50 | 1.00 | 1.00 | 0.50 | 1.00 |
| Hydroxyethyl cellulose | — | — | — | 0.05 | — | — | — | — |
| 10% microfibrillated cellulose | — | — | — | — | — | 1.00 | — | — |
| Xanthan gum | 0.23 | — | — | — | — | — | 0.17 | — |
| Diutan gum | — | 0.14 | — | — | — | — | — | — |
| Water | Q.S. | Q.S. | Q.S. | Q.S. | Q.S. | Q.S. | Q.S. | Q.S. |

| Composition | Y | Z | AB | AC | AD | AE |
|---|---|---|---|---|---|---|
| Metribuzin | 15.86 | 15.86 | 15.86 | 15.86 | 15.86 | 15.86 |
| Pyroxasulfone | 6.76 | 6.76 | 6.76 | 6.76 | 6.76 | 6.76 |
| Flumioxazin | 5.29 | 5.29 | 5.29 | 5.29 | 5.29 | 5.29 |
| 35% graft copolymer | — | — | — | — | — | — |
| Alkylphenol ethoxylate free | — | — | — | — | — | — |
| nonionic wetter and dispersant | | | | | | |
| package | | | | | | |
| A lignin, alkali, reaction product | 5.00 | 5.00 | 4.00 | — | — | 4.00 |
| with formaldehyde and sodium | | | | | | |
| bisulfite | | | | | | |
| An ethoxylated kraft lignosulfonate | — | — | — | — | — | — |
| Sodium alkyl naphthalene | — | 4.00 | 4.00 | 5.00 | 5.00 | 4.00 |
| sulfonate condensate | | | | | | |
| Propylene glycol | 4.00 | 4.00 | 4.00 | 4.00 | 4.00 | 4.00 |
| Glycerol | 10.00 | 10.00 | 10.00 | 10.00 | 10.00 | 10.00 |
| PVA (as active) | — | — | — | — | — | — |
| Ammonium sulfate | — | — | — | — | — | — |
| Silicone emulsion | 0.30 | 0.30 | 0.30 | 0.30 | 0.30 | 0.30 |
| 19.3% 1,2-benzisothiazolin-3-one | 0.20 | 0.20 | 0.20 | 0.20 | 0.20 | 0.20 |
| Magnesium aluminum silicate | 0.50 | 1.00 | 0.50 | 0.50 | 0.50 | 0.50 |
| Hydroxyethyl cellulose | — | — | — | — | — | — |
| 10% microfibrillated cellulose | — | — | — | — | — | — |
| Xanthan gum | 0.13 | — | 0.05 | 0.08 | 0.13 | 0.10 |
| Diutan gum | — | — | — | — | — | — |
| Water | Q.S. | Q.S. | Q.S. | Q.S. | Q.S. | Q.S. |

Morwet® D-425 is used as the source of sodium alkyl naphthalene sulfonate condensate and is a registered trademark of and available from Akzo Nobel Surface Chemistry LLC.

Reax® 907 was used as the source of a lignin, alkali, reaction product with formaldehyde and sodium bisulfite (Reax is a registered trademark of and available from Huntsman Petrochemical Corporation).

Reax® 1425E was used as the source of an ethoxylated kraft lignosulfonate (Reax is a registered trademark of and available from Huntsman Petrochemical Corporation).

Exilva® F 01-V was used as the source of 10% microfibrillated cellulose (Exilva is a registered trademark and available from Borregaard Chemical).

Kelco-Vis® DG was used as the source of diutan gum (Kelco-Vis is a registered trademark and available from CP Kelco).

### Method

Compositions from Table 7, above, was subjected to extreme temperatures to determine long-term storage stability including the likelihood of large crystals growing that cause clogging of the spray nozzle by performing the wet sieve test. Specifically, this composition containing was subjected to 2 weeks at 54° C. and 5 freeze/thaw cycles to simulate accelerated aging after which syneresis, particle size, crystal growth and viscosity were measured. Results of this study are shown in Table 8, below.

### Syneresis

Syneresis was determined by placing the composition in a 125-milliliter high density polyethylene (HDPE) bottle at the above-mentioned storage conditions. The height of the top clear liquid phase was then measured. Syneresis is calculated using the following equation: Height of top clear liquid phase/height of total sample.

A high syneresis value indicates poor formulation stability.

### Physical Stability

Physical stability is determined by particle size. Particle sizes were measured for each composition. D (v, 0.1), D (v, 0.5) and D (v, 0.9) values were measured. D (v, X) denotes the proportion of particles whose diameter measured below the given value in microns.

### Rheology Properties

The rheological property of viscosity was measured using Haak Mars Modular Advanced Rheometer System made by Thermo Scientific, model number: MARS 2.

### Crystal Growth

The wet sieve test was used to determine metribuzin crystal growth and typically was performed soon after the sample was brought back to room temperature using the following protocol:

A bottle containing the composition was emptied onto a 100-mesh sieve positioned on top of a receiver. Water was added to the bottle, shaken to rinse, and the rinse solution was poured onto the mesh to wash off the material. The rinsing step was repeated until visible quantity of residue on the mesh remained constant. If necessary, additional, minimum streams of water were introduced by way of a squirt or spray bottle to further clear the mesh. Typically, about 250 milliliters of water was used for about 40 grams of sample. The mesh was then dried to a constant weight and observed under a microscope.

TABLE 8

| Property | Condition | X | A | B | C | C-2 | D | E | F |
|---|---|---|---|---|---|---|---|---|---|
| % Syneresis | 54 C. 2 | 27.6 | 24.0 | 13.0 | 12.1 | 0.0 | 6.9 | 0.0 | 43.6 |
| | w F/T | 39.2 | 36.7 | 33.9 | 5.5 | 4.3 | 34.0 | 0.0 | 32.7 |
| Particle Size | Initial | 0.8 | 0.8 | 0.8 | 0.8 | 0.8 | 0.8 | 0.8 | 0.7 |
| (0.1) μm | 54 C. 2 | 1.0 | 1.0 | 1.1 | 1.0 | 0.9 | 1.1 | 0.9 | 0.9 |
| | w F/T | 0.8 | 0.9 | 0.9 | 0.9 | 0.8 | 0.8 | 0.9 | 0.7 |
| Particle Size | Initial | 2.1 | 2.1 | 2.1 | 2.1 | 2.0 | 2.1 | 2.0 | 1.9 |
| (0.5) μm | 54 C. 2 | 2.8 | 2.8 | 3.0 | 2.6 | 2.6 | 2.8 | 2.6 | 2.3 |
| | w F/T | 2.1 | 2.2 | 2.1 | 2.2 | 2.3 | 2.1 | 2.2 | 1.8 |
| Particle Size | Initial | 5.5 | 6.4 | 5.3 | 5.4 | 5.0 | 5.1 | 5.4 | 4.7 |
| (0.9) μm | 54 C. 2 | 7.0 | 6.8 | 6.8 | 6.9 | 6.9 | 6.6 | 7.2 | 5.7 |
| | w F/T | 5.5 | 5.3 | 5.2 | 5.8 | 6.2 | 5.2 | 5.4 | 4.7 |
| Large | Initial | No | No | No | No | No | No | No | No |
| crystals | 54 C. 2 | Yes | Yes | Yes | Yes | Yes | Yes | Yes | Yes |
| (under | w F/T | No | Yes | Yes | Yes | Yes | Yes | Yes | Yes |
| microscope) | | | | | | | | | |
| Viscosity | Initial | 166 | 205 | 164 | 544 | 875 | 423 | 553 | 267 |
| (mPa°s, | 54 C. 2 | 190 | 250 | 207 | 433 | N/A | 573 | 473 | 226 |
| @RT) | w F/T | 172 | 238 | 175 | 443 | 646 | 446 | 460 | 225 |

| Property | Condition | G | H | I | J | K | L | M | N |
|---|---|---|---|---|---|---|---|---|---|
| % Syneresis | 54 C. 2 | 52.8 | 5.8 | 13.0 | 27.3 | 31.1 | 0.0 | 0.0 | 6.3 |
| | w F/T | 39.3 | 4.0 | 5.2 | 13.5 | 20.0 | 0.0 | 0.0 | 15.4 |
| Particle Size | Initial | 0.8 | 0.7 | 0.7 | 0.7 | 0.7 | 0.7 | 0.7 | 0.7 |
| (0.1) μm | 54 C. 2 | 0.9 | 0.8 | 0.8 | 0.9 | 0.9 | N/A | N/A | 0.8 |
| | w F/T | 0.8 | 0.7 | 0.7 | 0.8 | 0.7 | 0.7 | 1.0 | 0.7 |
| Particle Size | Initial | 1.9 | 1.9 | 1.7 | 1.9 | 1.8 | 1.9 | 1.9 | 1.9 |
| (0.5) μm | 54 C. 2 | 2.3 | 2.0 | 2.0 | 2.2 | 2.0 | N/A | N/A | 2.0 |
| | w F/T | 1.9 | 1.9 | 1.9 | 2.0 | 1.8 | 2.0 | 4.7 | 1.9 |
| Particle Size | Initial | 4.4 | 5.0 | 4.0 | 5.0 | 4.4 | 4.8 | 4.8 | 4.8 |
| (0.9) μm | 54 C. 2 | 5.7 | 4.8 | 5.1 | 5.7 | 4.9 | N/A | N/A | 4.5 |
| | w F/T | 4.6 | 5.0 | 4.9 | 5.1 | 4.5 | 5.1 | 291.3 | 4.8 |
| Large | Initial | No | No | No | No | No | No | No | No |
| crystals | 54 C 2 | Yes | No | No | Yes | Yes | N/A | N/A | No |
| (under | w F/T | Yes | No | No | No | Yes | N/A | N/A | No |
| microscope) | | | | | | | | | |
| Viscosity | Initial | 219 | 1700 | 794 | 455 | 570 | 1914 | Too | 652 |
| (mPa°s, | | | | | | | | high | |
| @RT) | 54 C. 2 | 155 | 954 | 676 | 372 | 323 | N/A | N/A | 732 |
| | w F/T | 152 | 1444 | 1104 | 376 | 316 | Too | Too | 663 |
| | | | | | | | high | high | |

| Property | Condition | O | P | Q | R | T | U | V | W |
|---|---|---|---|---|---|---|---|---|---|
| % Syneresis | 54 C. 2 | 47.4 | 42.4 | 30.0 | 38.0 | 0.0 | 10.0 | 0.0 | 0.0 |
| | w F/T | 30.2 | 28.8 | 41.5 | 12.7 | 0.0 | 5.0 | 0.0 | 0.0 |
| Particle Size | Initial | 0.8 | 0.8 | 0.8 | 2.0 | 0.8 | 0.8 | 0.7 | 0.8 |
| (0.1) μm | 54 C. 2 | 0.8 | 0.8 | 0.8 | 1.2 | 0.8 | 0.7 | 0.7 | 0.8 |
| | w F/T | 0.8 | 0.8 | 0.8 | 1.5 | 0.8 | 0.8 | 0.7 | 0.7 |
| Particle Size | Initial | 1.9 | 1.9 | 2.0 | 105.2 | 1.9 | 1.9 | 1.8 | 2.0 |
| (0.5) μm | 54 C. 2 | 2.1 | 2.1 | 2.0 | 35.0 | 1.9 | 1.9 | 1.8 | 1.9 |
| | w F/T | 1.9 | 1.9 | 2.0 | 75.1 | 1.9 | 1.9 | 1.8 | 1.9 |
| Particle Size | Initial | 4.4 | 4.4 | 5.4 | 386.4 | 4.9 | 4.9 | 4.4 | 4.9 |
| (0.9) μm | 54 C. 2 | 4.9 | 5.5 | 5.0 | 278.5 | 4.9 | 4.9 | 4.3 | 4.8 |
| | w F/T | 4.5 | 4.4 | 5.2 | 332.9 | 4.6 | 4.5 | 4.0 | 4.8 |
| Large | Initial | No | No | No | No | No | No | No | No |
| crystals | 54 C. 2 | Yes | Yes | No | No | No | No | No | No |
| (under | w F/T | No | No | No | No | No | No | No | No |
| microscope) | | | | | | | | | |
| Viscosity | Initial | 286 | 303 | 75 | 199 | 227 | 444 | 385 | 328 |
| (mPa°s, | 54 C. 2 | 210 | 369 | 75 | 121 | 267 | 252 | 448 | 316 |
| @RT) | w F/T | 198 | 256 | 78 | 170 | 237 | 224 | 437 | 301 |

| Property | Condition | Y | Z | AB | AC | AD | AE |
|---|---|---|---|---|---|---|---|
| % Syneresis | 54 C. 2 | 4.7 | 4.7 | 17.7 | 12.7 | 6.6 | 6.7 |
| | w F/T | 0.0 | 4.8 | 5.8 | 6.9 | 0.0 | 0.0 |
| Particle Size | Initial | 0.8 | 0.8 | 0.8 | 0.7 | 0.8 | 0.8 |
| (0.1) μm | 54 C. 2 | 0.8 | 0.7 | 0.8 | 0.7 | 0.8 | 0.8 |
| | w F/T | 0.8 | 0.8 | 0.8 | 0.7 | 0.8 | 0.8 |
| Particle Size | Initial | 2.0 | 2.0 | 2.0 | 1.9 | 2.0 | 2.1 |
| (0.5) μm | 54 C. 2 | 1.9 | 2.0 | 1.9 | 1.8 | 2.1 | 2.1 |
| | w F/T | 1.9 | 1.9 | 2.0 | 1.8 | 2.2 | 2.2 |
| Particle Size | Initial | 5.0 | 5.3 | 4.9 | 4.5 | 4.9 | 5.8 |
| (0.9) μm | 54 C. 2 | 4.7 | 5.2 | 4.7 | 4.6 | 5.4 | 5.8 |
| | w F/T | 4.9 | 4.7 | 4.9 | 4.4 | 7.3 | 6.7 |
| Large | Initial | No | No | No | No | No | No |
| crystals | 54 C. 2 | No | No | No | No | No | No |
| (under | w F/T | No | No | No | No | No | No |
| microscope) | | | | | | | |
| Viscosity | Initial | 341 | 664 | 382 | 352 | 382 | 404 |
| (mPa°s, | 54 C. 2 | 311 | 398 | 230 | 243 | 348 | 319 |
| @RT) | w F/T | 330 | 369 | 255 | 227 | 311 | 377 |

“54 C. 2 w” denotes 2 weeks at 54 degrees Celsius
F/T denotes 5 freeze/thaw cycles

### Results

As can be seen in Table 8, Compositions X, A, B, D, F, G, J, K, O, P, Q and R had unacceptable syneresis (i.e. 20% or more). Further, Compositions X, A, B, C, C2, D, E, F, G, I, M and R had unacceptable particle sizes. Compositions C, C2, D, H, I, K, L, M, N and Q had unacceptable viscosities. Finally, Compositions X, A, B, C, D, E, F, G, J, K, O and P had large metribuzin crystal formation. Compositions T, U, V, W, Y, Z, AB, AC, AD and AE had acceptable levels of each of syneresis, particle size, viscosity and did not have any large metribuzin crystal growth formation. Thus, the addition of a polyoxyethylene alkyl sulfate results in physically stable formulations.

### Example 9—Tank Mix Compatibility

### Method

Compositions T, U, V, Z, AB, AD, and AE were chosen to further determine physical compatibility with several tank mix partners. Each of these compositions were mixed at 50% with 1) RoundUp Powermax®, 2) RoundUp Powermax® and Xtendimax®, 3) RoundUp Powermax® and Engenia®, 4) RoundUp Powermax® and Enlist One®, 5) Xtendimax®, 6) Engenia®, 7) Enlist One®, 8) FirstRate® and Enlist One® and 9) FirstRate®, RoundUp Powermax®, and Xtendimax® in 300 milliliter bottles and then measured for initial mixability, initial inversions required to mix, settling rate and inversions to re-suspend after 4 and 24 hours.

Roundup Powermax® is a 48.7% potassium salt of glyphosate, N-(phosphonomethyl)glycine formulation and is available from Monsanto Technology LLC.

XtendiMAX® is a 42.8% diglycolamine salt of dicamba (3,6-dichloro-o-anisic acid) formulation and is available from Monsanto Technology LLC.

Engenia® is a 60.8% dicamba: N,N-Bis-(3-aminopropyl)methylamine salt of 3,6-dichloro-o-anisic acid formulation and is available from BASF.

Enlist One® is a 55.7% 2,4-D choline salt formulation and is available from Corteva Agriscience.

FirstRate® is a 84% cloransulam-methyl: N-(2-carbomethoxy-6-chlorophenyl)-5-ethoxy-7-fluoro(1,2,4)triazolo-[1,5-c]pyrimidine-2-sulfonamide formulation is available from Dow AgroSciences.

### Results

Compositions AB and AD were considered to have acceptable compatibility with all tank mix partners.

What is claimed is:

1. An aqueous herbicidal composition comprising:
metribuzin;
flumioxazin;
pyroxasulfone; and
a polyoxyethylene alkyl sulfate.

2. The composition of claim 1, further comprising one or more excipients selected from the group consisting of a thickener, an antifoaming agent, an antifreeze agent and a preservative.

3. The composition of claim 2, wherein the thickener is selected from the group consisting of magnesium aluminum silicate, hydrophilic fumed silica, aluminum oxide, hydroxy alkyl celluloses, xanthan gum and mixtures thereof.

4. The composition of claim 3, wherein the composition comprises magnesium aluminum silicate and xanthan gum.

5. The composition of claim 1, wherein the polyoxyethylene alkyl sulfate is sodium alkyl naphthalene sulfonate condensate.

6. A method of controlling a weed comprising applying the composition of claim 1 to the weed or an area in need of weed control.

7. An herbicidal composition comprising:
from about 10% to about 20% w/w metribuzin;
from about 1% to about 15% w/w of flumioxazin;
from about 1% to about 10% w/w pyroxasulfone; and
from about 0.1% to about 8% w/w sodium alkyl naphthalene sulfonate condensate;
wherein w/w denotes weight by total weight of the composition.

8. The composition of claim 7, wherein:
metribuzin is present at a concentration from about 15% to about 17% w/w;
flumioxazin is present at a concentration from about 4% to about 12% w/w;
pyroxasulfone is present at a concentration from about 5% to about 7% w/w; and
sodium alkyl naphthalene sulfonate condensate is present at a concentration from about 4% to about 6% w/w.

9. The composition of claim 7, further comprising from about 0.1% to about 4% w/w magnesium aluminum silicate and from about 0.1% to about 4% w/w xanthan gum.

10. The composition of claim 9, wherein magnesium aluminum silicate is present at a concentration from about 0.1% to about 1% w/w and xanthan gum is from about 0.1% to about 1% w/w.

11. The composition of claim 7, further comprising:
from about 1% to about 7% w/w propylene glycol;
from about 5% w/w to about 15% w/w glycerol;
from about 0.05% to about 1% w/w of a silicone emulsion; and
from about 0.1% to about 1% w/w of 19.3% 1, 2-benzisothiazolin-3-one.

12. The composition of claim 11, wherein:
propylene glycol is present at a concentration from about 2% to about 6% w/w;
glycerol is present at a concentration from about 8% to about 12% w/w;
the silicone emulsion is present at a concentration from about 0.2% to about 0.4% w/w; and
19.3% 1, 2-benzisothiazolin-3-one is present at a concentration from about 0.1% to about 0.3% w/w.

13. A method of controlling a weed comprising applying the composition of claim 7 to the weed or an area in need of weed control.

14. An aqueous herbicidal composition comprising:
about 15.9% w/w metribuzin;
about 5.3% w/w flumioxazin;
about 6.8% w/w pyroxasulfone;
about 5% w/w of sodium alkyl naphthalene sulfonate condensate;
about 0.5% w/w magnesium aluminum silicate; and
about 0.13% w/w xanthan gum,
wherein w/w denotes weight by total weight of the composition.

15. The composition of claim 14, further comprising:
about 4% w/w propylene glycol;
about 10% w/w glycerol;
about 0.3% w/w of a silicone emulsion; and
about 0.2% w/w of 19.3% 1, 2-benzisothiazolin-3-one;

16. A method of controlling a weed comprising applying the composition of claim 14 to the weed or an area in need of weed control.
